(19) United States
(12) Patent Application Publication
(10) Pub. No.: US 2014/0236484 A1
(43) Pub. Date: Aug. 21, 2014

(54) NAVIGATION DEVICE AND NAVIGATION METHOD

(71) Applicants: Ryusuke Kinoshita, Tokyo (JP); Naomiki Komatsu, Tokyo (JP)

(72) Inventors: Ryusuke Kinoshita, Tokyo (JP); Naomiki Komatsu, Tokyo (JP)

(73) Assignee: MITSUBISHI ELECTRIC CORPORATION, Tokyo (JP)

(21) Appl. No.: 14/348,838

(22) PCT Filed: Dec. 27, 2011
(86) PCT No.: PCT/JP2011/080280

§ 371 Date: Mar. 31, 2014

(51) Int. Cl. G01C 21/00

(52) U.S. Cl. CPC G01C 21/00
USPC 701/533

(57) ABSTRACT

An object of the present invention is to provide navigation device and method, which are capable of preventing a user from erroneously recognizing a region, through which the user moves, while suppressing annoyance to the user, which follows guidance of a border. The navigation device according to the present invention includes: prefectural border detection means as border detector that searches front of a vehicle as a mobile body in a traveling direction on a map, and detects a plurality of borders (prefectural borders) on the map; and guidance means as border guidance unit that collectively guides the plurality of borders (prefectural borders) present in a predetermined range to the user based on a detection result in the prefectural border detection means.

### TECHNICAL FIELD

The present invention relates to a navigation device and a navigation method for a mobile body including a person, a vehicle, a train, a ship, an aircraft or the like, and particularly, relates to a navigation device suitable for being brought in or mounted on the vehicle, and to a navigation method thereof.

### BACKGROUND ART

In a navigation device to be mounted on a vehicle as an example of a mobile body, there is a navigation device, which is provided with a function to guide a border (prefectural border or the like) that defines regions to a user at predetermined timing so that the user can easily recognize a region (area and the like), through which the vehicle is traveling at present, a position of the border, or the like.

For example, in each of Patent Documents 1 to 3, there is disclosed a navigation device, which guides the prefectural border to the user, and allows the user to recognize a prefecture, through which the vehicle is traveling.

### PRIOR ART DOCUMENT

### Patent Document

Patent Document 1: Japanese Patent Application Laid-Open No. H08-14924

Patent Document 2: Japanese Patent Application Laid-Open No. H11-351899

Patent Document 3: Japanese Patent Application Laid-Open No. 2000-337893

### SUMMARY OF INVENTION

### Problems to be Solved by the Invention

However, there is also a case where guidance of the border, which is performed every time when the vehicle passes through the border, is annoying for the user.

For example, in Patent Document 1, in such a case where a plurality of the prefectural borders are present in a narrow distance range, and the vehicle travels through that region, guidance of the prefectural border is performed at a short time interval every time when the vehicle passes through the prefectural border, and accordingly, there has been a problem that the user is given an annoyance.

For this problem, there is disclosed a technology, in which a certain prefectural border is guided, and guidance of the same prefectural border (prefectural border in which an adjacent prefecture is common) located in a fixed section from the guided prefectural border is prohibited thereafter (refer to Patent Document 2).

However, in Patent Document 2, in a case where the vehicle repeatedly travels through the same prefectural border, even in such a case where the vehicle returns to an original prefecture before the guidance by the fact that the vehicle finally passes through the same prefectural border, guidance of a prefectural border, which is related to the prefectural border through which the vehicle finally passes, is not performed. Hence, there has been a problem that there is a possibility that the user may erroneously recognize the prefecture though which the vehicle is traveling.

Meanwhile, for the above-described problem that the user is given the annoyance, there is also disclosed a technology, in which, in a case where a distance between the plurality of prefectural borders belonging to the same prefecture is a predetermined value or less, guidance of a prefectural border, which is related to those prefectural borders, is prohibited (refer to Patent Document 3).

However, in Patent Document 3, in a case where the vehicle repeatedly travels through the prefectural borders belonging to the same prefecture, even in such a case where the vehicle enters a different prefecture by passing through the plurality of prefectural borders for which the guidance is prohibited, the guidance of the prefectural border is not performed. Hence, there has also been a problem that there is a possibility that the user may erroneously recognize the prefecture through which the vehicle is traveling.

The present invention has been made in order to solve the problems as described above, and an object of the present invention is to provide navigation device and method, which are capable of preventing the user from erroneously recognizing the region, through which the user is moving, while suppressing the annoyance to the user, which follows the guidance of the border.

### Means for Solving the Problems

A navigation device according to the present invention includes: border detection means for searching front of a mobile body in a traveling direction on a map and detecting a plurality of borders on the map; and border guidance means for collectively guiding the plurality of borders present in a predetermined range to a user based on a detection result in the border detection means.

A navigation method according to the present invention includes: (a) searching front of a mobile body in a traveling direction on a map and detecting a plurality of borders on the map; and (b) collectively guiding, to a user, the plurality of borders present in a predetermined range based on a detection result in the step (a).

### EFFECTS OF THE INVENTION

In accordance with the navigation device according to the present invention, there are provided: the border detection means for searching front of a mobile body in a traveling direction on a map and detecting a plurality of borders on the map; and the border guidance means for collectively guiding the plurality of borders present in a predetermined range to a user based on a detection result in the border detection means, whereby the user can be prevented from erroneously recognizing a region, through which the user moves, while suppressing the annoyance to the user, which follows the border guidance, by collecting the guidance.

In accordance with the navigation method according to the present invention, there are provided: (a) searching front of a mobile body in a traveling direction on a map and detecting a plurality of borders on the map; and (b) collectively guiding, to a user, the plurality of borders present in a predetermined range based on a detection result in the step (a), whereby the user can be prevented from erroneously recognizing the region, through which the user moves, while suppressing the annoyance to the user, which follows the border guidance, by collecting the guidance.

The object, features, aspects, and advantages of the present invention will become more apparent by the following detailed description and the accompanying drawings.

### BRIEF DESCRIPTION OF DRAWINGS

FIG. 1 is a conceptual configuration diagram showing a configuration of a navigation device.

FIG. 2 is a hardware configuration diagram showing the configuration of the navigation device.

FIG. 3 is a flowchart showing operations of the navigation device.

FIG. 4 is a view explaining the operations of the navigation device.

FIG. 5 is a view explaining the operations of the navigation device.

FIG. 6 is a view explaining the operations of the navigation device.

FIG. 7 is a flowchart showing the operations of the navigation device.

FIG. 8 is a view explaining the operations of the navigation device.

### DESCRIPTION OF EMBODIMENTS

### Embodiment 1

### <Configuration>

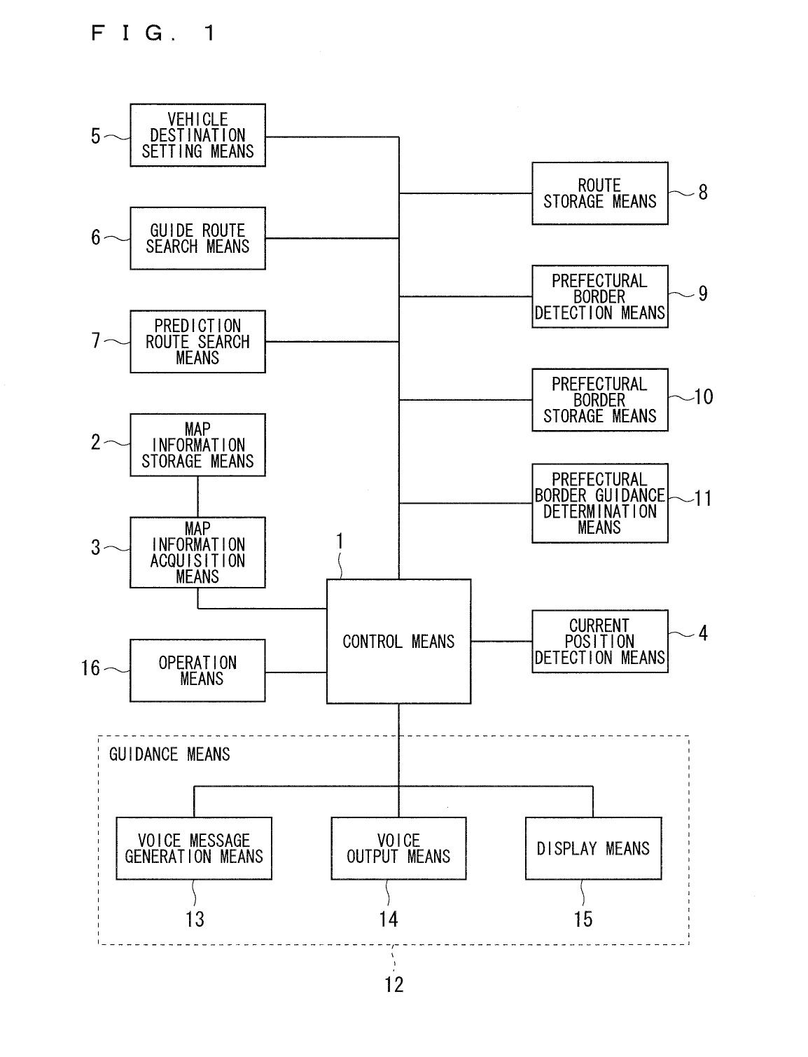

FIG. 1 is a block diagram showing a functional configuration of a navigation device according to Embodiment 1 of the present invention. The navigation device is a device that performs border guidance for a mobile body, and as a specific example, a description is particularly made of guidance of a prefectural border for a vehicle in this embodiment.

As shown in FIG. 1, respective pieces of functional means are connected to control means 1.

As the functional means to be thus connected, there are: map information acquisition means 3 for acquiring map information from map information storage means 2; current position detection means 4 for detecting a current position of a vehicle; destination setting means 5 for setting a destination of the vehicle; guide route search means 6 for searching for a guide route to the destination of the vehicle that is set in the destination setting means 5; predictive route search means 7 for searching for a predictive route to a fixed distance range in a case where the destination of the vehicle is not set; route storage means 8 for storing the set route (guide route or predictive route); prefectural border detection means 9 for detecting the prefectural border by searching the map information; prefectural border storage means 10 for storing the prefectural border; prefectural border guidance determination means 11 for determining whether or not to guide the prefectural border; guidance means 12 for executing the guidance of the prefectural border; and operation means 16 for receiving operations from a user.

The control means 1 is connected to the respective pieces of functional means, and thereby performs a variety of arithmetic operations in the navigation device and operation control for the whole of the device.

In the map information storage means 2, the map information is stored, which includes digital data such as node data, data of links which connect respective nodes to one another, prefectural border data, address data (prefecture code), road type data, and road approach angle data. Here, the prefectural border data is data indicating that a prefectural border is present on a certain point on the map, and the address data (prefecture code) is data indicating an address of the certain point on the map, or at least a prefecture to which the point belongs. Moreover, the road type data is data indicating a road type (highway, general road and the like), and the road approach angle data is data indicating an angle at which roads intersect each other at a crossing and the like.

In the map information acquisition means 3, the map information stored in the map information storage means 2 is acquired by the operation control of the control means 1.

In the current position detection means 4, the current position of the vehicle on which the navigation device is mounted is detected by the operation control of the control means 1. For example, such detection is performed based on positioning information obtained by using a GPS (Global Positioning System).

In the destination setting means 5, destination setting based on a map operation and an address retrieval that are made through operations for the operation means 16 by the user, is performed by the operation control of the control means 1.

In the guide route search means 6, by the operation control of the control means 1, a route between two points, the route departing from the current position of the vehicle and reaching the destination set by the destination setting means 5, is searched based on the map information stored in the map information storage means 2, and the route is set as the guide route. In the case where the guide route is set, a traveling direction of the vehicle is specified based on the guide route.

In the predictive route search means 7, in a case where the destination is not set yet, the predictive route to the fixed distance range is searched and set by the operation control of the control means 1. Here, the predictive route is set as a route as a result of predicting a route through which it is highly possible that the vehicle may travel. In a case where the predictive route is set, the traveling direction of the vehicle is specified based on the predictive route.

As a method of setting the above-described predictive route, for example, there is a method of setting a predictive route, in which a vehicle speed is maintained at a predetermined value or more and a change of the traveling direction of the vehicle is little, as the predictive route in such a manner that the type of the road in the traveling direction of the vehicle is selected by the road type data, and that an approach angle to the road is recognized by the road approach angle data.

In the route storage means 8, the route (guide route or predictive route) set in the guide route search means 6 or the predictive route search means 7 is stored.

The prefectural border detection means 9 detects the prefectural border on the route (guide route or predictive route), which is stored in the route storage means 8, by the operation control of the control means 1 based on the prefectural border data, the address data (prefecture code) and the like that are included in the map information. Detailed operations will be described later.

The prefectural border storage means 10 stores the prefectural border detected by the prefectural border detection means 9. Specifically, the prefectural border storage means 10 stores data of a position of the prefectural border, a prefecture as an approach destination in a vehicle approach direction, and the like as prefectural border information. Here, in a case where the position of the prefectural border is tentatively determined within a predetermined distance range, the prefectural border storage means 10 can store the distance range as the position of the prefectural border.

The prefectural border guidance determination means 11 determines whether or not to guide the prefectural border, which is stored in the prefectural border storage means 10, by the operation control of the control means 1. Specifically, the prefectural border guidance determination means 11 determines whether or not to guide the prefectural border, and further, determines at which timing the guidance of the prefectural border is to be performed. The determination is made based on a time taken until the vehicle reaches the point of the prefectural border, a distance from the current position of the vehicle to the point of the prefectural border, a predetermined prohibition condition, and the like. The predetermined prohibition condition will be described later.

The guidance means 12 is means for actually guiding the prefectural border, and includes: voice message generation means 13 for generating a voice message; voice output means 14 for executing output of a voice; and display means 15 for displaying a message and the like.

For a required guide content, the guidance means 12 generates the voice message by the voice message generation means 13 based on the operation control of the control means 1, and outputs (reproduces) the voice message, which is generated, by the voice output means 14. Moreover, the guidance means 12 displays an icon, a telop and the like on a screen of a liquid crystal display or the like by the display means 15.

Such a guidance operation is performed at predetermined timing determined in the prefectural border guidance determination means 11.

The operation means 16 includes a switch (input means) for operating this device in an event where the user sets the destination and the like, and manages an input signal inputted by the switch (input means).

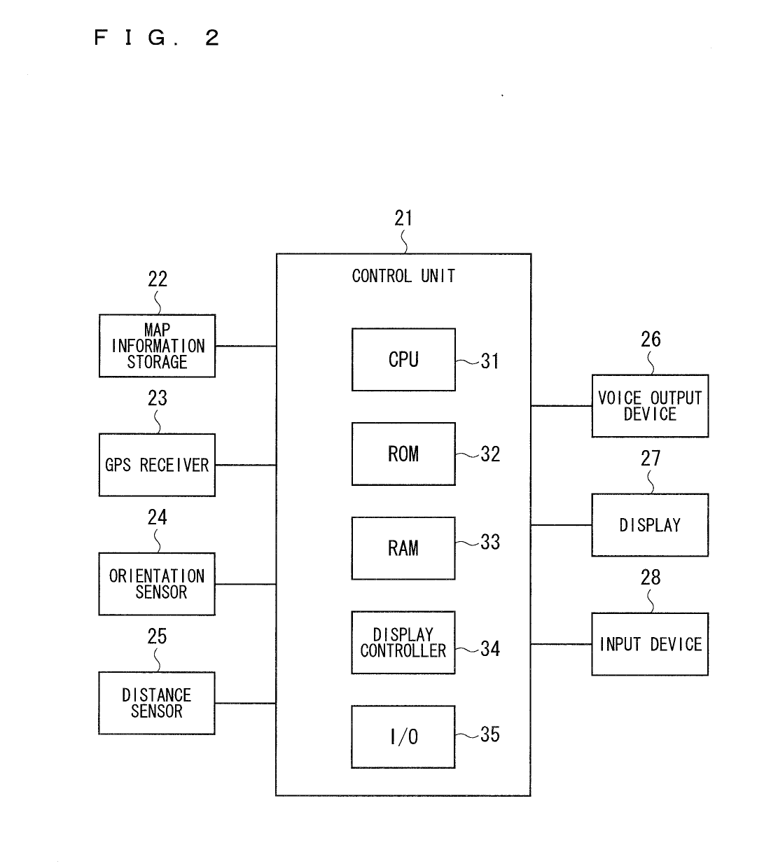

FIG. 2 is a block diagram showing a hardware configuration of the navigation device according to Embodiment 1 of the present invention.

As shown in FIG. 2, respective functional devices are connected to a control unit 21 (corresponding to the control means 1).

As the functional devices to be thus connected, there are connected: a map information storage 22 (corresponding to the map information storage means 2) that stores the map information; a GPS receiver 23 that receives position signals sent from several satellites located above the sky; an orientation sensor 24 for specifying the traveling direction of the vehicle; a distance sensor 25 that calculates a traveling distance of the vehicle, and the like; a voice output device 26 (corresponding to the voice output means 14) that outputs a voice; a display device 27 (corresponding to the display means 15); and an input device 28 (corresponding to the operation means 16).

The map information acquisition means 3, the destination setting means 5, the guide route search means 6, the predictive route search means 7, the route storage means 8, the prefectural border detection means 9, the prefectural border storage means 10, the prefectural border guidance determination means 11 and the voice message generation means 13 in FIG. 1 are those which realize functions of the control unit 21 in FIG. 2.

In particular, the current position detection means 4 in FIG. 1 realizes a current position detection operation, which is to be performed by the control unit 21, based on data acquired by the GPS receiver 23, the orientation sensor 24 and the distance sensor 25.

The control unit 21 performs the variety of operations in this navigation device and the operation control for the whole of the device.

The control unit 21 includes: a CPU (Central Processing Unit) 31; a ROM (Read Only Memory) 32; a RAM (Random Access Memory) 33; a display controller 34 that controls display on the display device 27; and an I/O (Input/Output) 35.

Here, the CPU 31 performs calculations for the search for the route (guide route or predictive route), the detection of the prefectural border, the determination of the prefectural border guidance timing, and the like.

In the ROM 32, program constants and the like, which are used by the CPU 31 in processes of operations such as the route search and the detection of the prefectural border. That is to say, besides programs for executing the search for the route (guide route or predictive route) from the current position to the destination and navigation such as guidance along the searched route, programs related to guidance of the prefectural border, which will be described later, are stored, and various pieces of data, which become necessary for those, are stored.

In the RAM 33, the programs, the map information and the like are developed in the processes of the processing by the CPU 31. Moreover, a result of the arithmetic operations is written.

The display controller 34 controls the display on the display device 27.

The I/O 35 serves as an interface between the control unit 21 and the respective external functional devices.

For example, the map information storage 22 includes: a recording medium such as an HDD (Hard Disk Drive) that stores the map information; and a readout device thereof.

The GPS receiver 23 receives radio waves sent from the artificial satellites, and information in the radio waves is used for the detection of the current position that is combined with information acquired by other sensors.

For example, the orientation sensor 24 is an angular velocity sensor or an earth magnetism sensor, and detects an orientation to which the vehicle is directed.

For example, the distance sensor 25 is a speed sensor, and detects a moving distance of the vehicle.

The voice output device 26 outputs guidance messages and the like by voice.

The display device 27 displays the map information, the route, the guide, the telop and the like on a display medium including a liquid crystal display for example.

The input device 28 receives signals for allowing the user to operate this navigation device.

### Operations

Next, with regard to operations of the guidance of the prefectural border, a description is made of an outline thereof with reference to FIG. 1. Control for the operations is performed in the control means 1.

First, the current position of the vehicle is detected in the current position detection means 4. The detection of the current position can be performed by using such GPS positioning as mentioned above.

Next, based on the detected current position of the vehicle, the necessary map information stored in the map information storage means 2 is acquired by the map information acquisition means 3. For example, the necessary map information is map information within a predetermined distance range in which the current position of the vehicle is taken as a center.

Next, a switch operation and the like are made by the user through the operation means 16, and the setting of the destination or the like on the map is performed by the destination setting means 5.

In a case where the destination is set by the destination setting means 5 based on the operation of the user, then based on the acquired map information (if necessary, the map information is further acquired by the map information acquisition means 3 in response to the destination), the guide route between two points, the guide route departing from the current position of the vehicle, which is detected in the current position detection means 4, and reaching the set destination, is searched and set in the guide route search means 6.

Meanwhile, in a case where the destination is not set by the destination setting means 5, then based on the acquired map information, the predictive route from the detected current position of the vehicle to the fixed distance range is searched and set in the predictive route search means 7. This predictive route is searched anew every time when the vehicle travels, and can be reset each time thereof.

The route (guide route or predictive route) searched by the guide route search means 6 or the predictive route search means 7 is stored in the route storage means 8.

Next, the prefectural border (border) on the route (guide route or predictive route) stored in the route storage means 8 is detected in the prefectural border detection means 9.

The detection of the prefectural border is performed on the route of the vehicle, and there are: a method of detecting the prefectural border on the whole of the set route; and a method of detecting the prefectural border in a predetermined range (hereinafter, detection range) on the route, for example, in a range from the current position of the vehicle to a predetermined point (search position) forward in the traveling direction.

In the method of detecting the prefectural border on the whole of the set route, a position of the prefectural border can be grasped in advance before the traveling of the vehicle. Meanwhile, in the method of detecting the prefectural border in the detection range, a range of the prefectural border to be detected can be grasped while being limited during the traveling of the vehicle, and a load on calculation processing and the like, which follow the detection operation, can be reduced. Setting of a time interval at which the prefectural border detection operation is to be performed and of the predetermined distance can be changed automatically or by the user, for example, based on a type of the road on which the vehicle is traveling, accuracy at which the prefectural border position is to be obtained, and the like.

As a method of determining the presence of the prefectural border, there are: a method of performing the determination based on whether or not the prefectural border data indicating the prefectural border can be detected on the route to the search position on the map; and a method of performing the determination based on whether or not a prefecture code of the search position is a prefecture code different from a prefecture code at other position (for example, the current position of the vehicle).

In a case of determining the presence of the prefectural border from the prefecture code, for example, it can be only recognized that at least one prefectural border is present on the route from the current position to the search position, and the accuracy of the prefectural border position that can be specified will be varied depending on a distance interval at which the prefectural border detection operation is to be performed. In a case where it is desired to be recognized that at least two prefectural borders are present, it is necessary to set two search positions.

The detected prefectural border is stored as the prefectural border information in the prefectural border storage means 10.

Next, based on the prefectural border information stored in the prefectural border storage means 10, it is determined whether or not to guide the prefectural border in the prefectural border guidance determination means 11. In a case of performing the guidance of the prefectural border, the guidance is performed collectively for the prefectural borders present in a predetermined range (hereinafter, guidance range). Here, the collective guidance of the prefectural border stands for that guidance of the plurality of prefectural borders which have become targets of the guidance in a single guidance operation is completed, that is, the guidance of the plurality of prefectural borders is completed (is ended, that is, is not guided again) in a single guidance phrase.

Among the detected prefectural borders, the plurality of prefectural borders present in the guidance range (for example, the range from the current position of the vehicle to the search position) on the route are not guided at timing at which each of the prefectural borders should be originally guided (for example, a point of time at which the prefectural border is located at a predetermined distance from the current position of the vehicle, or a point of time when the time until the vehicle reaches the prefectural border becomes a predetermined time), but are guided by a single guidance operation at timing preset for each of the prefectural border guidance operations (that is, timing when the vehicle does not go over all of the prefectural borders which become the guidance targets, and the like).

The prefectural border guidance is performed in such a manner that the required voice guidance message generated in the voice message generation means 13 is outputted in the voice output means 14, and that the display such as the telop and the icon, and the like are displayed by the display means 15 in that event.

In a case where the above-described prefectural border guidance is performed, then in the prefectural border guidance determination means 11, the guidance range where the prefectural borders which have become the targets of the collective guidance are present is set as a prohibited section, and the guidance of the prefectural borders present in the prohibited section is prohibited thereafter.

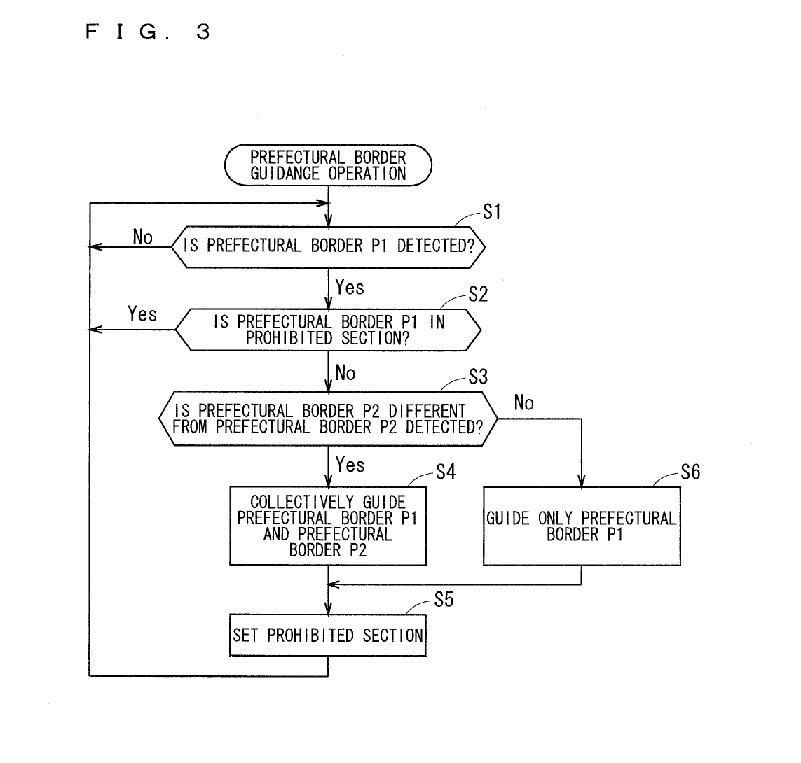

FIG. 3 is a flowchart showing the prefectural border guidance operation of the navigation device in a case where destination is set. Hereinafter, a description is specifically made of the prefectural border guidance operation of the navigation device according to Embodiment 1 by using the flowchart of FIG. 3, and FIGS. 4 to 6. Hereinafter, a description is made of a case of performing the prefectural border detection in the detection range on the guide route, which is also a case where the detection range and the guidance range are common to each other, and that range is set in a range from the current position of the vehicle to a second search position D2 to be described later.

In Step S1, first, it is detected whether or not a prefectural border P1 as a first border is present from a current position of a vehicle 100 to a point (first search position D1) forward in the traveling direction by a first detection range (distance) d1 (m) therefrom on the guide route from the current position of the vehicle 100 to the destination (refer to FIG. 4 to FIG. 6). The detection is performed in the prefectural border detection means 9.

Here, the prefectural border P1 can be defined as a prefectural border located closest to the first search position D1 on a route from the current position of the vehicle 100 to the first search position D1. In usual, the distance to the first search position D1 is set at a relatively short distance, and accordingly, the number of the prefectural borders which can be present on the route from the current position of the vehicle 100 to the first search position D1 is one; however, even in such a case where the plurality of prefectural borders are present on the route from the current position of the vehicle 100 to the first search position D1, a prefectural border immediately before the first search position D1 can be defined as the prefectural border P1.

For example, if a plurality of the prefectural border data can be detected on the route to the first search position D1, then prefectural border data immediately before the first search position D1 can be employed among those prefectural border data, and the prefectural border P1 can be detected on the route from the current position of the vehicle 100 to the first search position D1. Regarding the prefectural border P1, information about the point of the prefectural border, a prefecture as an approach destination, and the like is acquired, the information being based on the prefectural border data immediately before the first search position D1.

Moreover, in a case where the prefectural border is detected from the prefecture code, in a case where the prefecture code of the first search position D1 is the prefecture code different from the prefecture code at the current position of the vehicle, it can be defined that the prefectural border P1 is detected on the route from the current position of the vehicle 100 to the first search position D1. Regarding the prefectural border P1, information about a presence range of the prefectural border, the prefecture as the approach destination, and the like, which is based on the position of the first search position D1 on the map and the prefecture code thereof, is acquired.

In the case where the prefectural border P1 can be detected, then the prefectural border guidance operation proceeds to Step S2, and if the prefectural border P1 cannot be detected, then the prefectural border is not guided, and the prefectural border guidance operation returns to Step S1.

In Step S2, it is determined whether or not the prefectural border P1 detected in Step S1 is the prefectural border in the prohibited section already set in Step S5. That is to say, it is determined whether or not the position (position range) of the prefectural border P1 belongs to the prohibited section. In a case where the determination is performed based on the position range of the prefectural border P1, in a case where all of the position range is included in the prohibited section, it is determined that the prefectural border P1 is the prefectural border in the prohibited section. The determination is performed in the prefectural border guidance determination means 11.

If the prefectural border P1 is the prefectural border in the prohibited section, then the prefectural border P1 is the prefectural border already defined as the target of the collective guidance, and accordingly, the prefectural border guidance operation returns to Step S1, and the detected prefectural border P1 is not guided. If the prefectural border P1 is a prefectural border out of the prohibited section, then the prefectural border guidance operation proceeds to Step S3. Note that, before the prohibited section is set in Step S5, that is, at a stage where the collective guidance is not performed yet, it is determined that the prefectural border P1 is the prefectural border out of the prohibited section, and the prefectural border guidance operation proceeds to Step S3.

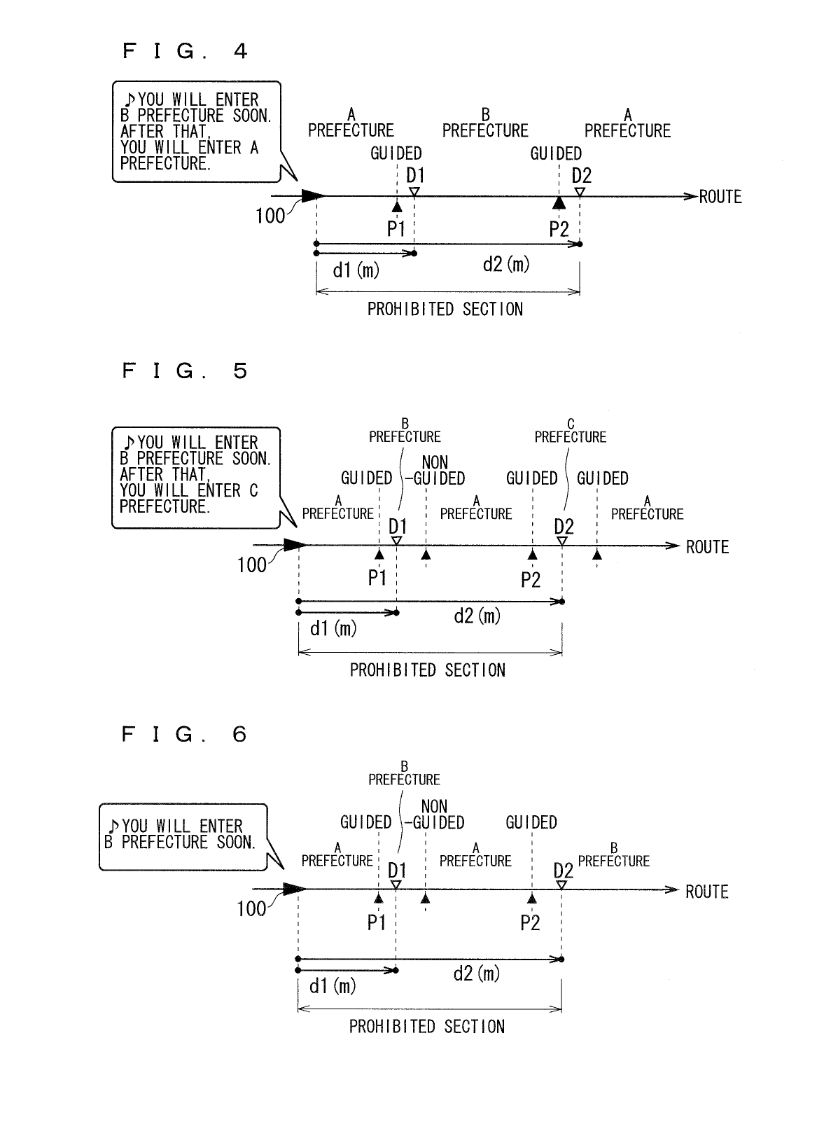

In Step S3, it is detected whether or not a prefectural border P2 as a second border “different” from the prefectural border P1 is present between the first search position D1 and a point (second search position D2) forward in the traveling direction by a second detection range (distance) d2 (m) from the current position of the vehicle 100 on the guide route to the destination (however, there is established a relationship of: second detection range (distance) d2>first detection range (distance) d1). This detection is performed in the prefectural border detection means 9. Here, the prefectural border P2 is a prefectural border located closest to the second search position D2 in the section from the first search position D1 to the second search position D2. That is to say, even in such a case where the plurality of prefectural borders are present in the section from the first search position D1 to the second search position D2, a prefectural border immediately before the second search position D2 is defined as the prefectural border P2 (refer to FIG. 5).

Moreover, the prefectural border P2 “different” from the prefectural border P1 refers to such a prefectural border P2 that the vehicle 100 enters, by crossing it, a prefecture different from a prefecture that the vehicle 100 enters by crossing the prefectural border P1 in front of the vehicle 100 in the traveling direction. That is to say, for example in FIG. 4, the prefecture that the vehicle 100 enters by crossing the prefectural border P1 is B prefecture, and the prefecture that the vehicle 100 enters by crossing the prefectural border P2 is A prefecture, and accordingly, both of the prefectural borders P1 and P2 become prefectural borders different from each other.

For the prefectural border data, in a case where a prefecture, which is an approach destination in the prefectural border data immediately before the second search position D2, and a prefecture, which is an approach destination in the prefectural border data immediately before the first search position D1, are different from each other, then it can be defined that the prefectural border P2 different from the prefectural border P1 is detected on a route from the first search position D1 to the second search position D2.

Moreover, for the prefecture code, in a case where the prefecture code of the second search position D2 is acquired, and the acquired prefecture code is a prefecture code different from that in the first search position D1, then it can be defined that the prefectural border P2 different from the prefectural border P1 is detected on the route from the first search position D1 to the second search position D2.

If the above-described prefectural border P2 different from the prefectural border P1 cannot be detected, then the prefectural border guidance operation proceeds to Step S6, and in a case where the prefectural border P2 different from the prefectural border P1 can be detected, then the prefectural border guidance operation proceeds to Step S4.

In Step S6, guidance related to the prefectural border P1 that is the prefectural border present in the guidance range is performed in the guidance means 12. Here, in a case of proceeding to this flow, there are: a case where the prefectural border is not detected in the detection range; and a case where the prefectural border P2 that is the same prefectural border as the prefectural border P1 is detected (in the above, this case is limited to the case where the prefectural border guidance operation is performed based on the prefectural border data), and even in any of the cases, the guidance related to the prefectural border P1 is performed.

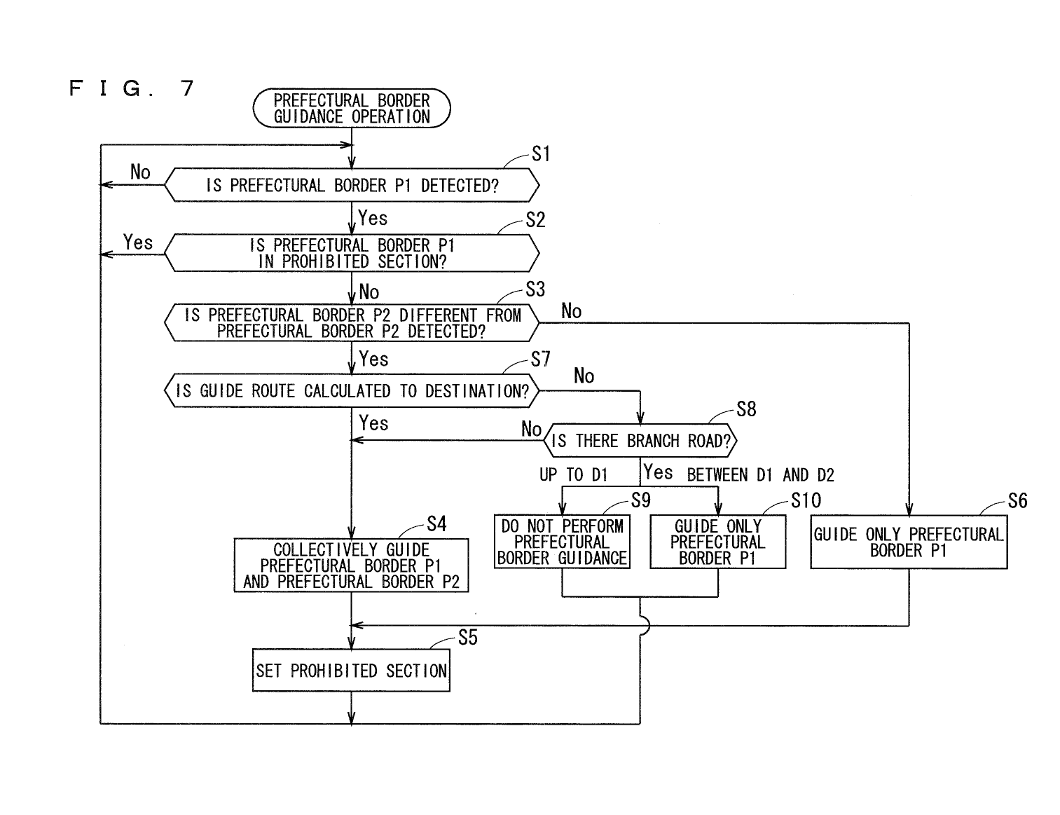

A reason why the above-described operation is performed also in the case where the prefectural border P2 that is the same as the prefectural border P1 is detected is in order to avoid repetition of the same phrase in a case where the prefectural border P1 and the prefectural border P2 are guided collectively. In an event of collectively performing the guidance operations for the prefectural border P1 and the prefectural border P2, duplicate guide contents can be guided in a lump. Specifically, such guidance, which says “You will enter B prefecture soon. After that, you will enter B prefecture”, is avoided, but such guidance, which says “You will enter B prefecture” (refer to FIG. 6), is performed, whereby the duplicate guide contents can be collected to one. Note that, in the prefectural border P1 and the prefectural border P2, the phrase to be guided therefore is the same, and accordingly, in the case where the prefectural border P2 that is the same prefectural border as the prefectural border P1 is detected, it can be said that the guidance operation collects guidance of both as guidance of the prefectural border P2. After the guidance is performed, the prefectural border guidance operation proceeds to Step S5.

In Step S4, the prefectural border P1 and the prefectural border P2, which are the prefectural borders present in the guidance range, are collectively guided in the guidance means 12. This guidance is performed in such a manner that the required voice guidance message generated in the voice message generation means 13 is outputted in the voice output means 14 and is notified to the user. Specifically, such a voice guidance message as “You will enter B prefecture soon. After that, you will enter A prefecture” (refer to FIG. 4) is outputted so that the prefectures as the approach destinations can be guided at the prefectural border P1 and the prefectural border P2. Moreover, in that event, the display such as the telop and the icon, and the like are displayed by the display means 15.

In Step S5, the route from the current position of the vehicle 100 to the second search position D2, the route having already been searched for the collective guidance, is set as the prohibited section. This setting is performed in the prefectural border guidance determination means 11.

While the prohibited section is being set, the prefectural border that belongs to the section set as the prohibited section is not defined as the target of the guidance even in a case of being detected in a subsequent prefectural border detection operation. In the case where the prefectural border has a predetermined presence range, the prefecture border is not defined as the target of the guidance in a case where all of the presence range is included in the prohibited section. Note that it is possible to continue the prefectural border detection operation also for a period while the vehicle 100 is traveling through the prohibited section.

Also with regard to the case where the same prefectural border P2 as the prefectural border P1 is detected in a flow proceeding to Step S6, since the guidance of the prefectural border P1 and the guidance of the prefectural border P2 are already collected in the single guidance phrase, these prefectural borders are not defined as the targets of the guidance even in a case of being detected in the subsequent prefectural border detection operation while the prohibited section is being set.

Moreover, in such a case where the plurality of prefectural borders are present at least on the route from the current position of the vehicle 100 to the first search position D1 or on the route from the first search position D1 to the second search position D2, other prefectural borders which are not detected as the prefectural border P1 and the prefectural border P2 are not defined as the targets of the guidance if the other prefectural borders belong to the prohibited section (refer to FIG. 5 and FIG. 6).

The setting of the prohibited section is occasionally released from a position, through which the vehicle 100 passes, at a point of time of this passage. After the setting is performed, the prefectural border guidance operation returns to Step S1.

In the above-described operation, a length of the first detection range (distance) D1 (m) can be set automatically or by the user in consideration of a moving speed of the vehicle 100, the road type, timing at which the prefectural border is desired to be detected, and the like. For example, in a case where the first detection range (distance) d1 (m) is set several ten meters ahead from the vehicle 100, then while running the vehicle 100, the prefectural border P1 can be detected in the range to the first search position D1, and further, the prefectural border P2 can be detected in the range from the first search position D1 to the second search position D2.

Moreover, a length of the second detection range (distance) d2 (m) can be set depending on whether or not to perform the prefectural border guidance at a time frequency at which the user of the vehicle feels annoyed. A reason for this is as follows. That is to say, if the second detection range (distance) d2 is shortened, even if the prefectural borders in the section to the second search position D2 are guided collectively, the vehicle passes through the prohibited section immediately, and an opportunity of the next prefectural border guidance comes.

Hence, in order that the prefectural borders cannot be guided at a shorter interval than the predetermined time interval, desirably, the length of the second detection range (distance) d2 (m) is set in consideration of the speed of the vehicle 100, the road type and the like. This setting may be set automatically based on these elements, or may be set in such a manner that the user designates the time or the distance.

By performing the operation in accordance with the flowchart as described above, there are effects as follows.

For example as shown in FIG. 4, the prefectural border P1 and the prefectural border P2 that the vehicle 100 enters, by crossing them, the different prefectures present in the guidance range are guided collectively (refer to Step S4), whereby annoyance to the user can be reduced more than by a conventional method of individually guiding the prefectural border P1 and the prefectural border P2. Moreover, the guidance of the prefectural borders, which becomes necessary, is performed as appropriate, and accordingly, the user can be prevented from erroneously recognizing the prefecture through which the vehicle 100 travels.

Moreover, after the prefectural border P1 and the prefectural border P2 are guided collectively, the section from the current position of the vehicle 100 to the second search position D2 is defined as the prohibited section where the guidance is prohibited (refer to Step S5), whereby the guidance of the prefectural borders guided collectively is prohibited, simple guidance to the user is enabled, and the annoyance following the guidance can be reduced.

Moreover, as shown in FIG. 5, in the case where the plurality of prefectural borders are present on the route from the first search position D1 to the second search position D2, the prefectural border located immediately before the second search position D2 is defined as the prefectural border P2 in the section from the first search position D1 to the second search position D2, whereby the prefectural border guidance can be performed while limiting the prefectural borders necessary to be guided, and a region, through which the vehicle of the user travels, can be prevented from being erroneously recognized while reducing the annoyance to the user. Note that, even in the case where the plurality of prefectural borders are present on the route from the current position of the vehicle to the first search position D1, the prefectural border located immediately before the first search position D1 can be defined as the prefectural border P1 in the section from the current position of the vehicle to the first search position D1.

Moreover, for example as shown in FIG. 6, in the case where the prefectural border P2, which is the same prefectural border as the prefectural border P1, is detected, the guidance operation collects guidance of both as the guidance of the prefectural border P1 (or the prefectural border P2) (refer to Step S6), whereby the same phrase can be avoided being repeated in the guidance, and prefectural border guidance, which is easy to understand for the user, can be realized. Moreover, even in such a case, the section to the second search position D2 is defined as the prohibited section, and the guidance of the prefectural border P1 and the prefectural border P2, which are collected and guided, is prohibited thereafter, whereby the simple guidance to the user is enabled.

### Modification Example

In FIG. 1 and FIG. 2, a method of connecting the functional constituents is not limited to wired connection, and may be the one that uses a network and the like.

Moreover, in the prefectural border detection operation in the case where the destination of the vehicle is set, it is not necessary that the predictive route search means 7 be provided among the constituents shown in FIG. 1. Furthermore, the guidance means 12 is not limited to the configuration including the voice message generation means 13, the voice output means 14, the display means 15, which are illustrated.

Moreover, it is not necessary that the map information storage means 2, the route storage means 8 and the prefectural border storage means 10, which are shown in FIG. 1, be provided in the navigation device, and may be provided in an external device communicable therewith through the network and the like.

Moreover, in this embodiment, it is premised that the navigation device is mounted on the vehicle; however, may be a navigation device, which is connected through the network and the like, and thereby instructs the route guide of the vehicle and the prefectural border guidance from the outside of the vehicle.

Moreover, in this embodiment, only the prefectural border P1 immediately before the first search position D1 and the prefectural border P2 immediately before the second search position D2 are defined as the targets of the prefectural border guidance, and the two prefectural borders are guided collectively; however, for example, in the event of collectively guiding the prefectural border P1 and the prefectural border P2 (refer to Step S4), it is also possible to contain guidance of other prefectural border detected based on the prefectural border data. Moreover, the search positions are further increased, whereby it is also possible to detect other prefectural borders and to contain the detected other prefectural borders in the guidance.

Furthermore, in a case where a plurality of the prefectural border positions can be detected based on the prefectural border data, the search positions may be limited to one, that is, for example, the first search position D1 may be omitted, and the plurality of prefectural borders to the second search position D2 may be guided collectively.

### Effects

In accordance with the embodiment of the present invention, in the navigation device, there are provided: the prefectural border detection means 9 as border detection means for searching, on the map, the front of the vehicle 100 as a mobile body in the traveling direction, and detecting the plurality of prefectural borders on the map; and the guidance means 12 as border guidance means for collectively guiding, to the user, the plurality of prefectural borders present in the guidance range as the predetermined range based on detection results in the prefectural border detection means 9, whereby the user can be prevented from erroneously recognizing the prefecture, through which the vehicle of the user travels, while suppressing the annoyance to the user, which follows the border guidance.

Moreover, for example, in the case where the detection range where the prefectural border detection is performed is defined as the whole of the route, then among the prefectural borders detected in the detection range, only the prefectural borders present in the guidance range, in which the current position of the vehicle 100 is taken as a reference, are guided collectively, whereby the presence of the prefectural borders present on the route can be grasped in advance, the guidance operation can be restricted to the range necessary thereamong, and convenience is enhanced.

Moreover, in accordance with the embodiment according to the present invention, in the navigation device, the prefectural border detection means 9 as the border detection means searches, on the map, the detection range located in front of the vehicle 100 as the mobile body in the traveling direction, and detects the plurality of prefectural borders on the map, which are present in the range, and the guidance means 12 as the border guidance means collectively guides the plurality of prefectural borders, which are present in the guidance range, to the user, whereby the user can be prevented from erroneously recognizing the prefecture, through which the vehicle of the user travels, while suppressing the annoyance to the user, which follows the border guidance.

Moreover, the detection range where the prefectural border detection is performed is limited to the same range as the guidance range, whereby the prefectural border detection can be performed only for the range that becomes necessary for performing the collective guidance of the prefectural borders, an arithmetic operation processing load for the prefectural border detection can be reduced, and an operation speed can be enhanced.

Moreover, in accordance with the embodiment according to the present invention, in the navigation device, in the case where two borders which are the prefectural border P1 and the prefectural border P2 are present in the range from the current position of the vehicle to the second search position D2, the guidance means 12 as the border guidance means collectively guides the prefectural border P1 and the prefectural border P2 to the user, whereby the user can be prevented from erroneously recognizing the prefecture, through which the vehicle of the user travels, by guiding the prefectural border P2, while suppressing the annoyance to the user.

Furthermore, in accordance with the embodiment of the present invention, in the navigation device, in the case where the prefectural borders as three or more borders are present in the range from the current position of the vehicle to the second search position D2 (refer to FIG. 5), the guidance means 12 as the border guidance means collectively guides, to the user, the prefectural border P1 as a first border in the traveling direction in the range and the prefectural border P2 as a final border therein, whereby the prefectural border guidance can be performed while limiting the prefectural borders necessary to be guided, and the prefecture, through which the vehicle of the user travels, can be prevented from being erroneously recognized while reducing the annoyance to the user.

Moreover, in accordance with the embodiment according to the present invention, in the navigation device, in the case where the approach region located in front of the plurality of prefectural borders in the traveling direction, the borders being present in the range from the current position of the vehicle to the second search position D2 is the same, the guidance means 12 as the border guidance means collects guidance of the plurality of prefectural borders as guidance of any of the prefectural borders, whereby the same phrase can be avoided from being repeated in the guidance of the plurality of prefectural borders which have become the targets of the collective guidance, and the prefectural border guidance, which is easy to understand for the user, can be realized.

Furthermore, in accordance with the embodiment of the present invention, in the navigation device, the guidance means 12 as the border guidance means does not perform the guidance of the borders, which have become the targets of the collective guidance, repeatedly as guidance different from the collective guidance, whereby, even in a case where the prefectural border already defined as the target of the collective guidance is detected in a process where the vehicle 100 is going to travel, the guidance of the prefectural border can be suppressed, the simple guidance to the user is enabled, and the annoyance following the guidance can be reduced.

Specifically, after the collective guidance is performed, the section from the current position of the vehicle 100 to the second search position D2 is defined as the prohibited section, and the guidance of the prefectural border belonging to the section is prohibited, whereby the above-described effect is realized.

Moreover, in accordance with the embodiment of the present invention, in the navigation device, the prefectural border detection means 9 as the border detection means detects, on the map, the prefectural border P1 as the first border between the current position of the vehicle 100 as the mobile body and the first search position D1 located in front of the vehicle 100 in the traveling direction, and in the case of having detected the prefectural border P1, detects, on the map, the prefectural border P2 as the second border between the first search position D1 and the second search position D2 further in front of the first search position D1 in the traveling direction.

Then, the guidance means 12 as the border guidance means collectively guides the prefectural border P1 and the prefectural border P2, which are present between the current position of the vehicle 100 and the second search position D2 on the route as the predetermined range, and does not guide the prefectural border P1 and the prefectural border P2 repeatedly as guidance different from the collective guidance up to the prohibited section being released.

The navigation device is operated in such a manner as described above, whereby, in the case where the prefectural border P1 is detected in the range from the current position of the vehicle 100 to the first search position D1, the prefectural border P2, which should be guided collectively with the prefectural border P1, can be searched in the range from the first search position D1 to the second search position D2, and the user can be prevented from erroneously recognizing the prefecture, through which the vehicle of the user travels, while suppressing the annoyance to the user, which follows the border guidance.

Moreover, in accordance with the embodiment of the present invention, in a navigation method, there are provided: (a) a step of searching the front of the vehicle 100 as the mobile body in the traveling direction on the map, and detecting the plurality of borders (prefectural borders) on the map; and (b) a step of collectively guiding, to the user, the plurality of prefectural borders present in the guidance range as the predetermined range based on a detection result in the step (a), whereby the user can be prevented from erroneously recognizing the prefecture, through which the vehicle of the user travels, while suppressing the annoyance to the user, which follows the border guidance, by collecting the guidance.

### Embodiment 2

### <Operation>

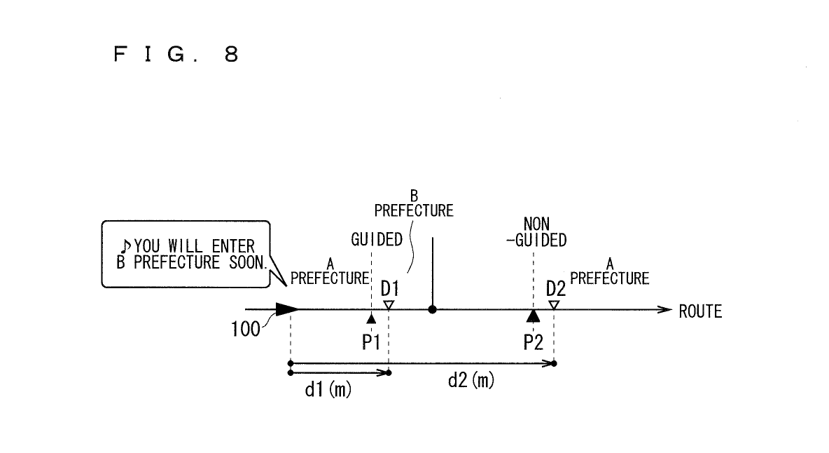

FIG. 7 is a flowchart showing operations also including a case where the destination is not set, the operations being performed by a navigation device having a similar configuration to that of Embodiment 1. A description is specifically made below of the prefectural border guidance operation of the navigation device according to Embodiment 2 by using the flowchart of FIG. 7 and FIG. 8. A detailed description of flows similar to those of Embodiment 1 is omitted.

After the end of the operations up to Step S3, if the prefectural border P2 different from the prefectural border P1 cannot be detected, then the operations proceed to Step S6, and in a case where the prefectural border P2 different from the prefectural border P1 can be detected, then the operations proceed to Step S7. In a case where the operations proceed to Step S6, the operations shown in Embodiment 1 are performed.

In Step S7, it is determined whether the above-described route, on which the prefectural border P1 and the prefectural border P2 are detected, is the guide route calculated by the guide route search means 6 or the predictive route calculated by the predictive route search means 7. This determination is performed in the prefectural border guidance determination means 11. In a case where the route is the guide route calculated by the guide route search means 6, the operations proceed to Step S4, and further to Step S5, and the operations shown in Embodiment 1 are performed. In a case where the route is the predictive route calculated by the predictive route search means 7, the operations proceed to Step S8.

In Step S8, it is determined whether or not the predictive route from the current position of the vehicle 100 to the second search position D2 has a branch road that can be branched to a road other than this predictive route. This determination is performed in the prefectural border guidance determination means 11.

Here, the branch road can include all of points such as intersections, each of which has a plurality of traveling directions. However, in a case where which traveling direction the vehicle selects among the plurality of traveling directions and travels therein can be specified in advance, for example, based on the road type, the approach angle and the like, it is also possible not to contain the point in the branch road even if the point has the plurality of traveling directions. Setting as to whether or not the road is defined as the branch road may be performed automatically based on an element such as the road type, the approach angle and the like, or may be performed in advance by the user.

In a case where there is no branch road, the operations proceed to Step S4, and further to Step S5, and the operations shown in Embodiment 1 are performed. In a case where there is a branch road, it is determined whether the branch road is located on the predictive route from the current position of the vehicle 100 to the first search position D1 or is located on the predictive route from the first search position D1 to the second search position D2. In a case where the branch road is located on the predictive route from the current position of the vehicle 100 to the first search position D1, the operations proceed to Step S9, and in a case where the branch road is located on the predictive route from the first search position D1 to the second search position D2, the operations proceed to Step S10.

In Step S9, the guidance of the prefectural border P1 and the prefectural border P2 is not performed, and the operations return to Step S1. In Step S10, in the guidance means 12, the guidance of only the prefectural border P1 as the prefectural border present in the guidance range is performed, and the operations return to Step S1.

In the predictive route calculated by the predictive route search means 7, there is a case where the user does not travel along the predictive route. If the collective guidance including the road on which the user does not travel is performed, then the user is given confusion, and accordingly, for the prefectural border on the predictive route after (forward in the traveling direction) the section where the branch road is present, the operations are controlled so as not to perform the prefectural border guidance.

In a case where the operations return to Step S1 through Step S9 and Step S10, the setting (refer to Step S5) of the prohibited section is not performed, and accordingly, the prefectural border detected up to the second search position D2 is defined as the target of the guidance in a case of being detected in the subsequent prefectural border detection operation.

The operations are performed in accordance with the flowchart as described above, whereby there are effects as follows.

For example as shown in FIG. 8, in a case where the branch road at which the user can select a plurality of the traveling directions is present on the predictive route from the first search position D1 to the second search position D2, the collective guidance of the prefectural border P1 and the prefectural border P2 is prohibited, and only the prefectural border P1 is guided. The operations are performed as described above, whereby the guidance of the prefectural border P2, which should be undesirably guided during the collective guidance, and through which it is possible that the vehicle may not travel, is suppressed, and the user can be suppressed from being given the confusion.

Note that, in a case where a width of the branch road is less than a predetermined value, it is not necessary that the prefectural border P1 or the prefectural border P2 be excluded from the guidance.

### Modification Example

In the prefectural border detection operation in the case where the destination of the vehicle is not set, it is not necessary that the guide route search means 6 be provided among the constituents shown in FIG. 1.

### Effect

In accordance with the embodiment according to the present invention, in the navigation device, in the case where there is a branch road on the predictive route, the guidance means 12 as the border guidance means excludes the border, which is present in front of the branch road on the predictive route in the traveling direction, from the collective guidance, whereby the user can be suppressed from being given the confusion by the collective guidance containing the road on which the vehicle does not travel.

Note that, in the scope of the present invention, the present invention is capable of free combination of the respective embodiments, or modification of arbitrary constituent elements of the respective embodiments, or omission of arbitrary constituent elements in the respective embodiments.

Note that, in the embodiments described above, the description has been made of the examples of guiding the prefectural borders; however, needless to say, the present invention can be applied to a case of guiding geographical borders without being limited to the prefectural borders.

### EXPLANATION OF REFERENCE NUMERALS

1 control means, 2 map information storage means, 3 map information acquisition means, 4 current position detection means, 5 destination setting means, 6 guide route search means, 7 prediction route search means, 8 route storage means, 9 prefectural border detection means, 10 prefectural border storage means, 11 prefectural border guidance determination means, 12 guidance means, 13 voice message generation means, 14 voice output means, 15 display means, 16 operation means, 21 control unit, 22 map information storage, 23 GPS receiver, 24 orientation sensor, 25 distance sensor, 26 voice output device, 27 display device, 28 input device, 31 CPU, 32 ROM, 33 RAM, 34 display controller, 35 I/O, 100 vehicle, D1 first search position, D2 second search position, P1, P2 prefectural border

1-12. (canceled)

13. A navigation device comprising:
a border detector that searches front of a mobile body in a traveling direction on a map and detects a plurality of borders on said map; and
a border guidance unit that collectively guides said plurality of borders present in a predetermined range to a user based on a detection result in said border detector means.

14. The navigation device according to claim 13,
wherein said border detector searches, on the map, said predetermined range in front of said mobile body in said traveling direction and detects, on said map, a plurality of borders present in the range, and
said border guidance unit collectively guides said plurality of borders present in said predetermined range to said user.

15. The navigation device according to claim 13,
wherein, in a case where two of said borders are present in said predetermined range, said border guidance unit collectively guides the two of said borders to said user.

16. The navigation device according to claim 13,
wherein, in a case where three or more of said borders are present in said predetermined range, said border guidance unit collectively guides, to said user, a first border and a final border in said traveling direction in said predetermined range.

17. The navigation device according to claim 15,
wherein, in a case where approach regions in front of said plurality of borders in said traveling direction, said borders being present in said predetermined range, are identical, said border guidance unit collects guidance of said plurality of borders as guidance of any of said borders.

18. The navigation device according to claim 16,
wherein, in a case where approach regions in front of said plurality of borders in said traveling direction, said borders being present in said predetermined range, are identical, said border guidance unit collects guidance of said plurality of borders as guidance of any of said borders.

19. The navigation device according to claim 13,
wherein said border guidance unit avoids guiding said borders, said borders having become targets of said collective guidance, repeatedly as guidance different from the collective guidance.

20. The navigation device according to claim 13, further comprising:
a guide route searcher that searches for a guide route that guides movement of said mobile body,
wherein said traveling direction of said mobile body is specified based on said guide route.

21. The navigation device according to claim 13, further comprising:
a predictive route searcher that searches for a predictive route that predicts movement of said mobile body,
wherein said traveling direction of said mobile body is specified based on said predictive route.

22. The navigation device according to claim 21,
wherein, in a case where a branch road is present in said predetermined range on said predictive route, said border guidance unit is allowed to exclude, from said collective guidance, said border present more in front of said branch road in said traveling direction on said predictive route.

23. The navigation device according to claim 13, wherein
said border detector has:
a function to detect a first border between a current position of said mobile body and a first search position located in front of said mobile body in said traveling direction on said map; and
a function to detect, in a case where said first border is detected, a second border between said first search position and a second search position further in front of said first search position in said traveling direction on said map, and
said border guidance unit has:
a function to collectively guide, to said user, said first border and said second border that are present in a section between the current position of said mobile body and said second search position, the section serving as said predetermined range; and
a function to avoid guiding said first border and said second border repeatedly as guidance different from said collective guidance.

24. A navigation method comprising the steps of:
(a) searching front of a mobile body in a traveling direction on a map and detecting a plurality of borders on said map; and
(b) collectively guiding, to a user, said plurality of borders present in a predetermined range based on a detection result in said step (a).
